(19) United States
(12) Patent Application Publication
(10) Pub. No.: US 2024/0249220 A1
(43) Pub. Date: Jul. 25, 2024

(54) COST FORECASTING AND MONITORING FOR CLOUD INFRASTRUCTURE

(71) Applicant: Kyndryl, Inc., New York, NY (US)

(72) Inventors: Omar Odibat, Cedar Park, TX (US); Mouleswara Reddy Chintakunta, Allagadda (IN); Manish Mitruka, Pune (IN); Reagan Mitchell, Austin, TX (US); Umar Mohamed Iyoob Umar, Pflugerville, TX (US); Anand Bandaru, Bangalore (IN); Gail Camille Guerrero, Plano, TX (US); Divya Devaraj, Coimbatore (IN)

(21) Appl. No.: 18/157,376

(22) Filed: Jan. 20, 2023

(51) Int. Cl. G06Q 10/0631; G06Q 10/04

(52) U.S. Cl. CPC G06Q 10/06313; G06Q 10/04

(57) ABSTRACT

Disclosed embodiments provide a computer-implemented method for cloud computing infrastructure cost forecasting. Resource profiles are computed for one or more cloud resources. A scheduled pattern detection process is performed for each of the one or more cloud resources to check for periodic behaviors. A similar consumer detection process is performed for each of the one or more cloud resources to identify other entities that have a similar cloud computing resource usage pattern, which can serve as supervised learning data for neural networks of disclosed embodiments. Data is input to a neural network, where the input data includes the resource profile, an operational maturity score, and/or one or more similar consumer patterns, in order to obtain a cost forecast from the neural network, based on the input data.

### FIELD

The present invention relates generally to computer systems, and more particularly, to cost forecasting and monitoring for cloud infrastructure.

### BACKGROUND

Cloud computing is a method of delivering computing services over the internet, including servers, storage, networks, software, and analytic data. Cloud computing includes several components that work together to provide a computing service over the internet. These components include the physical servers, storage devices, and networking equipment that make up the cloud infrastructure. Another component is the virtualization software that is used to create virtual machines (VMs) on the hardware infrastructure, allowing multiple VMs to run on the same physical server. Other components include the cloud platform that enables the creation, deployment, and management of cloud-based services and applications, as well as the services and applications that users interact with when using the cloud. Examples of cloud services include storage, computing, networking, and database management. Users such as companies and government institutions choose cloud computing to reduce costs, gain flexibility, and improve security. As cloud services, including virtual machines, cloud storage, and cloud security, are easily scalable, it is a way to support continuity even during times of rapid growth.

Cloud computing is growing rapidly and the market for the technology is expected to continue to increase. The cloud computing paradigm has revolutionized the computing industry and enabled many applications, business models and enterprises, which otherwise wouldn't have been possible. Immediate availability, scalability, minimal capital expenditure and streamlined developer experience are its main advantages. Cloud computing can reduce the capital expense of buying hardware and software, as well as the personnel for managing the infrastructure. Overall, cloud computing allows organizations to access and use computing resources on demand, without having to invest in and maintain their own physical infrastructure. However, cloud computing has costs for renting/leasing services and resources. These costs can be significant, and may impact the operations of an enterprise.

### SUMMARY

In one embodiment, there is provided a computer-implemented method for cloud computing infrastructure cost forecasting, comprising: computing a resource profile for at least one cloud resource; performing a scheduled pattern detection process for each of the at least one cloud resources; performing a consumer detection process for each of the at least one cloud resources to generate at least one similar consumer pattern; computing an operational maturity score for the at least one cloud resources; inputting data to a neural network, wherein the input data includes the resource profile, the operational maturity score, the at least one similar consumer pattern; an output of the scheduled pattern detection process; and an output of the similar consumer detection process; and obtaining a cost forecast from the neural network, based on the input data.

In another embodiment, there is provided an electronic computation device comprising: a processor; a memory coupled to the processor, the memory containing instructions, that when executed by the processor, cause the electronic computation device to: compute a resource profile for at least one cloud resource; perform a scheduled pattern detection process for each of the at least one cloud resources; perform a consumer detection process for each of the at least one cloud resources to generate at least one similar consumer pattern; compute an operational maturity score for the at least one cloud resources; input data to a neural network, wherein the input data includes the resource profile, the operational maturity score, the at least one similar consumer pattern; an output of the scheduled pattern detection process; and an output of the similar consumer detection process; and obtain a cost forecast from the neural network, based on the input data.

In yet another embodiment, there is provided a computer program product for an electronic computation device comprising a computer readable storage medium having program instructions embodied therewith, the program instructions executable by a processor to cause the electronic computation device to: compute a resource profile for at least one cloud resource; perform a scheduled pattern detection process for each of the at least one cloud resources; perform a consumer detection process for each of the at least one cloud resources to generate at least one similar consumer pattern; compute an operational maturity score for the at least one cloud resources; input data to a neural network, wherein the input data includes the resource profile, the operational maturity score, the at least one similar consumer pattern; an output of the scheduled pattern detection process; and an output of the similar consumer detection process; and obtain a cost forecast from the neural network, based on the input data.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an ecosystem for embodiments of the present invention.

FIG. 5 is a flow diagram showing details of embodiments of the present invention.

FIG. 6 is a flow diagram showing additional details of embodiments of the present invention.

FIG. 7 is a block diagram for cost forecasting in accordance with embodiments of the present invention.

FIG. 8A shows exemplary forecast data.

FIG. 8B shows rendering of additional information in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Cost forecasting for cloud computing resources is important for successful operation of an enterprise such as a company or government institution. Managers, administrators, and/or other stakeholders benefit from a clear understanding of historical cloud computing costs, as well as accurate forecasting. This information can be used to analyze cost variance and assess budget compliance. Additionally, the information can help determine which assets and services are the primary items contributing to cloud computing costs. By identifying the root causes for changes in forecast costs, the stakeholders have the tools to make decisions to reduce those costs before they are incurred.

While some trends are based on seasonality, cloud cost forecasting does not always operate based on seasonal trends. There are various resources that can be added or removed due to unplanned business events, global events, and changing market conditions. Disclosed embodiments serve to improve the understanding of sudden increases and decreases in the cost of cloud computing resources. By incorporating machine learning, resource profiling, and pattern detection, disclosed embodiments can provide improved forecasting of cloud computing resources. Disclosed embodiments utilize natural language processing (NLP) to collect data and explain sudden cost increases or decreases. Additionally, anomaly detection and alert generation serve to warn stakeholders if projected costs are estimated to exceed budgetary constraints.

Disclosed embodiments provide a computer-implemented method for cloud computing infrastructure cost forecasting. Resource profiles are computed for one or more cloud resources. A scheduled pattern detection process is performed for each of the one or more cloud resources to check for periodic behaviors. A similar consumer detection process is performed for each of the one or more cloud resources to identify other entities that have a similar cloud computing resource usage pattern, which can serve as supervised learning data for neural networks of disclosed embodiments. Data is input to a neural network, wherein the input data includes the resource profile, an operational maturity score, and/or one or more similar consumer patterns, in order to obtain a cost forecast from the neural network, based on the input data.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

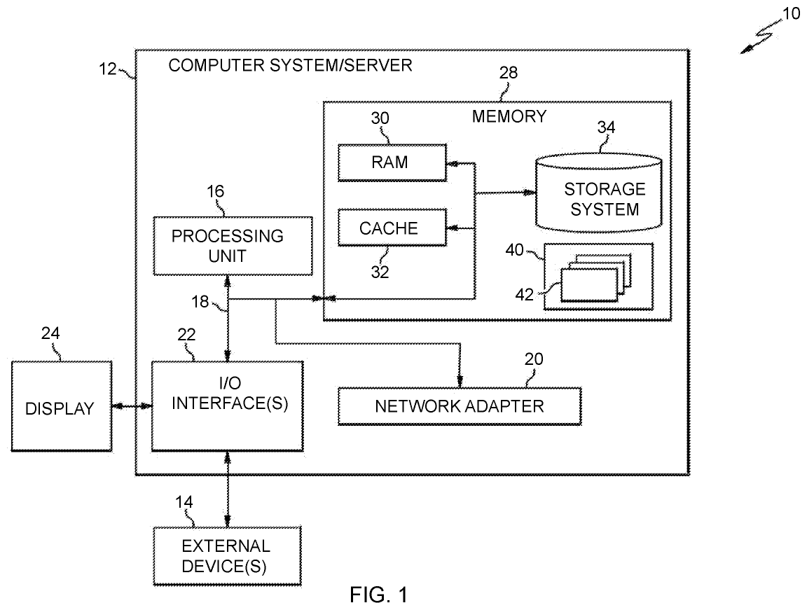

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

Computer system/server 12 typically includes a variety of computer system readable media. Such media may be any available media that is accessible by computer system/server 12, and it includes both volatile and non-volatile media, removable and non-removable media.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

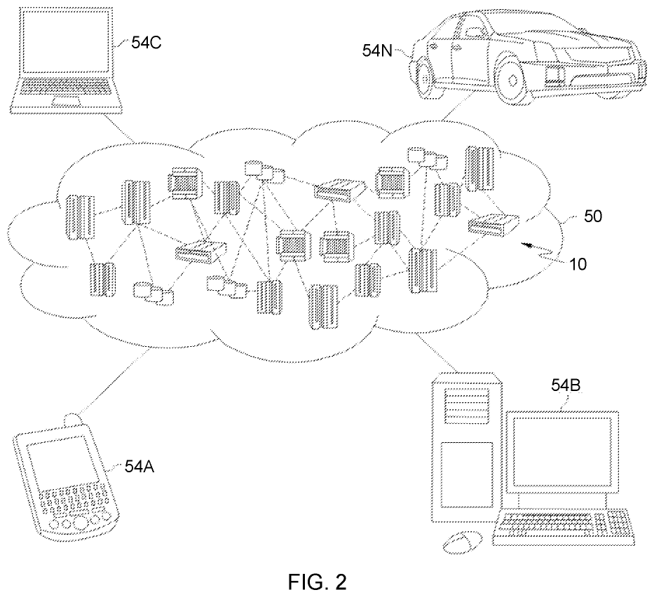

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

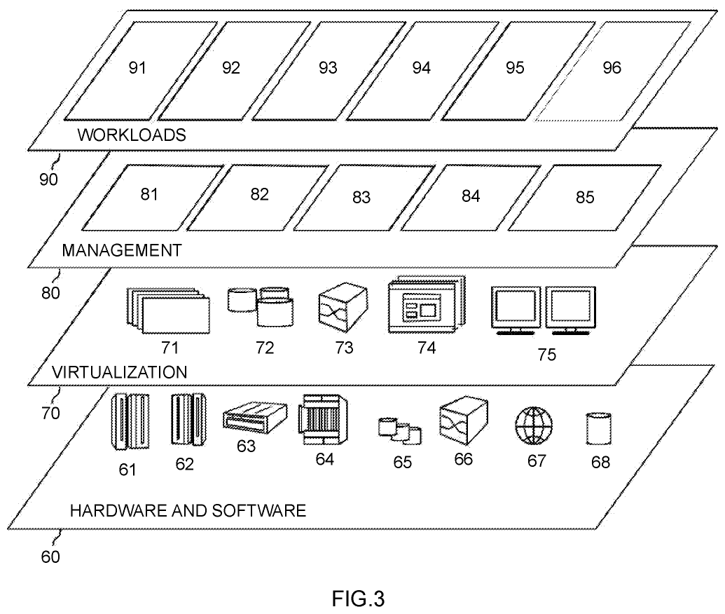

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cloud computing cost forecasting system 96.

Implementations of the invention may include a computer system/server 12 of FIG. 1 in which one or more of the program modules 42 are configured to perform (or cause the computer system/server 12 to perform) one of more functions of the cloud computing cost forecasting system 96 of FIG. 3. For example, the one or more of the program modules 42 may be configured to: obtain data items from data sources; classify the data items into categories using a first machine learning (ML) model; generate a risk score of a first data center based on the classified data items and using a second machine learning (ML) model; determine the risk score of the first data center exceeds a threshold; and in response to the determining the risk score of the first data center exceeds the threshold, initiate a migration of the first data center to a second data center.

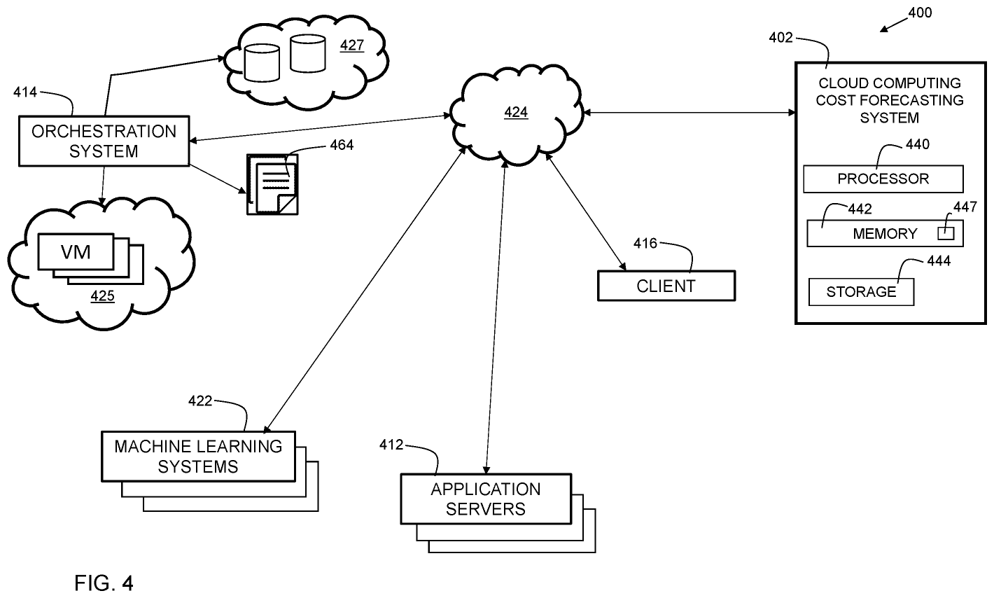

FIG. 4 is an ecosystem 400 for embodiments of the present invention. Cloud Computing Cost Forecasting System (CCCFS) 402 comprises a processor 440, a memory 442 coupled to the processor 440, and storage 444. System 402 is an electronic computation device. The memory 442 contains program instructions 447, that when executed by the processor 440, perform processes, techniques, and implementations of disclosed embodiments. Memory 442 can include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 444 may include one or more magnetic storage devices such as hard disk drives (HDDs). Storage 444 may additionally include one or more solid state drives (SSDs). The CCCFS 402 is configured to interact with other elements of ecosystem 400. CCCFS 402 is connected to network 424, which can include the Internet, a wide area network, a local area network, and/or other suitable network.

Ecosystem 400 may include one or more client devices, indicated as 416. Client device 416 can include a laptop computer, desktop computer, tablet computer, smartphone, or other suitable computing device. Client device 416 may be used to configure CCCFS 402.

Ecosystem 400 may include one or more machine learning systems 422. The machine learning systems 422 can include, but are not limited to, a convolutional neural network (CNN), Recurrent Neural Network (RNN), Long Short Term Memory Network (LSTM), Radial Basis Function Network (RBFN), Multilayer Perceptron (MLP), Gradient Boosted Network, and/or other suitable neural network types. In some embodiments, the CCCFS 402 may orchestrate training and inputting data and receiving of output data from the machine learning systems 422. In some embodiments, one or more of the aforementioned neural networks may be implemented with the CCCFS 402.

Cloud Computing Cost Forecasting System (CCCFS) 402 may interface with an orchestration system 414 that uses one or more programs to deploy, scale, and manage machines and software in a cluster as an orchestration environment. Non-limiting examples of such programs/systems are Kubernetes, Apache Hadoop, and Docker. Applications operating on such a system can include database applications such as Oracle database systems utilizing structured query language (SQL) databases. Note that the terms “KUBERNETES, ORACLE, APACHE, HADOOP, and DOCKER” may each be subject to trademark rights in various jurisdictions throughout the world. Each is used here only in reference to the products or services properly denominated by the mark to the extent that such trademark rights may exist. The orchestration system 414 may manage one or more cloud-based virtual machines 425 and/or one or more cloud-based storage repositories 427. A virtual machine (VM) is an operating system or application environment that is installed as software, which imitates dedicated hardware. The virtual machine provides the end user with the same experience on the virtual machine as they would have on dedicated hardware. The orchestration system 414 may output one or more files 464 to indicate status and/or operational conditions of the virtual machines 425 and/or storage repositories 427. The files 464 can be text-based log files, XML files, JSON files, and/or other suitable files. In embodiments, Cloud Computing Cost Forecasting System (CCCFS) 402 may perform natural language processing (NLP) on the files to obtain information about cloud resources. The information can include an operational status, such as running, waiting, deleted, etc. The information can include utilization statistics, including, but not limited to, processor utilization, memory utilization, and/or network bandwidth utilization. The files can include log files, billing data, and/or other text data associated with cloud-based resources. The information obtained from NLP can be used to infer a status of the health of cloud resources, and also be used as inputs to machine learning systems 422 for use in predicting future costs of operating the cloud-based systems.

Ecosystem 400 may include one or more application servers 412. The application servers 412 may utilize cloud-based services from virtual machines 425 and/or storage repositories 427. The application servers 412 may implement HTML-based user interfaces and provide backend functionality to support features and functions such as e-commerce, banking, reservations, and/or financial applications, to name a few.

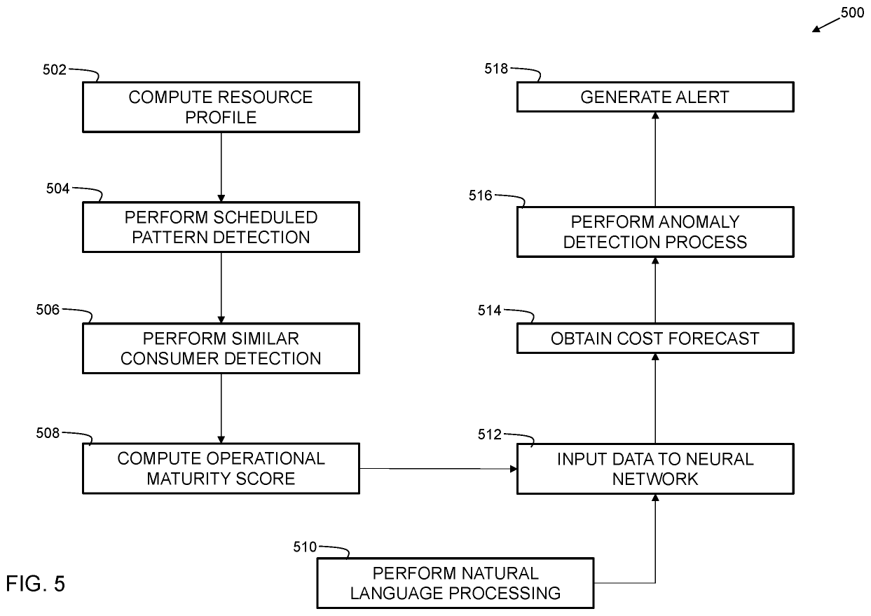

FIG. 5 is a flow diagram 500 showing details of embodiments of the present invention. At 502, a resource profile is computed for one or more cloud resources. The cloud resources can include, but are not limited to, virtual machines, containers, storage, databases, log file storage and analysis, and others. The resource profile can include classifying a resource as a production resource or a non-production resource. A non-production resource may be a temporary resource, and/or a resource that is currently in pre-deployment testing. In contrast, a production resource may include a fully tested and deployed resource. The deployment status (production or non-production) can be used by disclosed embodiments as part of the cloud resource cost prediction. The resource duration (temporary or permanent) can also be used by disclosed embodiments as part of the cloud resource cost prediction. In embodiments, this information may be retrieved from resource description files. The resource description files can include files in a variety of formats, including, but not limited to, text, CSV (comma-separated values), JSON (JavaScript Object Notation), XML (Extensible Markup Language), and/or YAML. As an example, if a resource is considered as temporary, then for forecasting purposes, an alternative cloud resource may be identified by disclosed embodiments to use in place of the temporary resource. Similarly, a cloud resource in pre-deployment status may be offered free of charge or at a reduced price. For future forecasting, that cost may change upon the cloud resource obtaining a “General Acceptance” status and becoming fully deployed. Disclosed embodiments may identify this upcoming change in status and include it in future cloud resource cost forecasting.

At 504, scheduled pattern detection is performed. Embodiments can include analyzing a historical pattern for each of the one or more cloud resources; and identifying a periodicity for the historical pattern. In embodiments, the historical pattern includes one of, weekly, quarterly, weekend, and daily. In embodiments, the pattern detection may include graphing one or more cloud resource costs as a function of time, and identifying local maxima and/or minima. Peaks exhibiting regular intervals can be identified, and the interval can be classified based on its duration, such as weekly, monthly, quarterly, daily, continuous, and/or other identifiable pattern. Some costs may be fixed and billed on a monthly, or quarterly basis. Other costs are based on usage, such as the amount of storage, computation, etc. that is used. In some cases, this usage has a regular pattern. Disclosed embodiments can identify the regular pattern and use it as criteria for cloud resource cost forecasting.

The flow can include performing similar consumer detection 506. This can include analyzing data in a consumer database for similar cloud resource usage. In embodiments, other consumers (e.g., other companies that use similar cloud computing resources) may opt in to allow their data to be used as part of a knowledgebase. In some embodiments, the data may be anonymized such that sensitive information such as the name and/or location of the company may be stripped from the data in the knowledgebase. Certain metadata may be partially obfuscated and/or generalized prior to entry into the knowledgebase. As an example, a company with 783 employees located in Chicago may be generalized to a company with 1,000 employees located in North America. In this way, when a given organization with a similar number of employees also located in North America wishes to perform cloud computing cost forecasting, real-world data from similarly sized and located companies can be used as inputs to a neural network (machine learning system) to perform supervised learning on the neural network to train it to make cost forecasting predictions.

The flow can include computing an operational maturity score 508. In embodiments, computing the operational maturity score comprises inputting resource utilization and cloud service type into the neural network. The cloud service type can include, but is not limited to, IaaS (Infrastructure as a Service), SaaS (Software as a Service), and/or PaaS (Platform as a Service). With PaaS, hardware and an application-software platform are provided and managed by an outside service provider, but the user handles the actual application and data. SaaS is a service that delivers a web application, which the service provider manages, to its users typically through a web browser. Software upgrades, defect fixes, and other general software maintenance are taken care of for the user, and they connect to the app through a dashboard or API. SaaS also eliminates the need to have an application installed locally on each individual user's computer, simplifying management of the ecosystem. In general, IaaS offerings require the customer to handle more layers of management than PaaS and SaaS options. Each of these “as-a-service” offerings has tradeoffs in terms of cost, flexibility, and convenience. While the level of service varies, each of these offerings has a cost, and sometimes, that cost can be unpredictable and difficult to understand. This unpredictability is not conducive to successful business operations. Disclosed embodiments reduce the unpredictability of cloud resource costs, as well as improve the understanding of previously incurred cloud services costs, to allow stakeholders of a business to better understand the source of costs, as well as plan accordingly for future costs. The operational maturity score can be computed based on a variety of inputs, including a level of utilization of the resource. This can help to identify underutilized or unused resources. The score can also include identifying cost optimization opportunities such as discount plans and/or committed use discounts. If plans such as these exist and are being used, it can affect the operational maturity score. The operational maturity score is a metric that can indicate a level of potential savings that is available. Recommendations to take advantage of these savings may be provided as functionality of disclosed embodiments.

The flow can include performing natural language processing 510. The natural language processing (NLP) can be performed on text files, such as log files, cloud resource description files, project reports, and/or other documentation. In some embodiments, internal and/or external websites may be scraped for text that is analyzed by NLP. The analysis can be used to aid in explaining sudden cost increases and/or decreases, thereby helping to demystify the difficult task of understanding the causes of fluctuations in the price of cloud computing resources. This can serve to explain spikes in costs in both historical data, as well as future forecasts. The natural language processing can include entity detection, disambiguation, and/or other NLP techniques. In embodiments, the NLP can be performed by machine learning systems 422 (FIG. 4).

The flow includes inputting the operational maturity score and/or outputs of natural language processing into a neural network at 512. The neural network can include a neural network that has been trained using supervised and/or unsupervised learning techniques. In some embodiments, the neural network may include an input layer, an output layer, and multiple hidden layers to receive a set of weighted inputs and produce outputs via an activation function. The flow includes obtaining a cost forecast 514 based on output from the neural network. The cost forecast can be for a duration including a week, a month, a quarter, a year, and/or other suitable durations.

The flow can include performing an anomaly detection process 516. In response to detecting an anomaly, an alert can be generated at 518. Embodiments can include generating an alert in response to detecting an anomaly from the anomaly detection process. In embodiments, the anomaly detection process comprises a customer-defined anomaly detection process. In embodiments, the anomaly detection process comprises a data-driven anomaly detection process. With a customer-defined anomaly detection process, disclosed embodiments generate an alert if the cost of a given cloud computing resource exceeds a user's predefined threshold. In embodiments, an anomaly includes a condition when a cost exceeds a predetermined threshold and/or previous historical data for a similar timeframe. In some embodiments, the predefined threshold can be a currency amount (e.g., US Dollars, Euros, etc.). In some embodiments, the predefined threshold can be indicated as a percentage increase. As an example, a cost that increases more than ten percent over the previous time period can be used as a criterion for generating an alert. With a data-driven anomaly detection process, the machine learning system identifies patterns that are inconsistent with historical data. In this way, customers can be alerted to anomalies even if they did not specify particular criteria for triggering alerts. The alerts can be generated for historical usage and/or forecasted data.

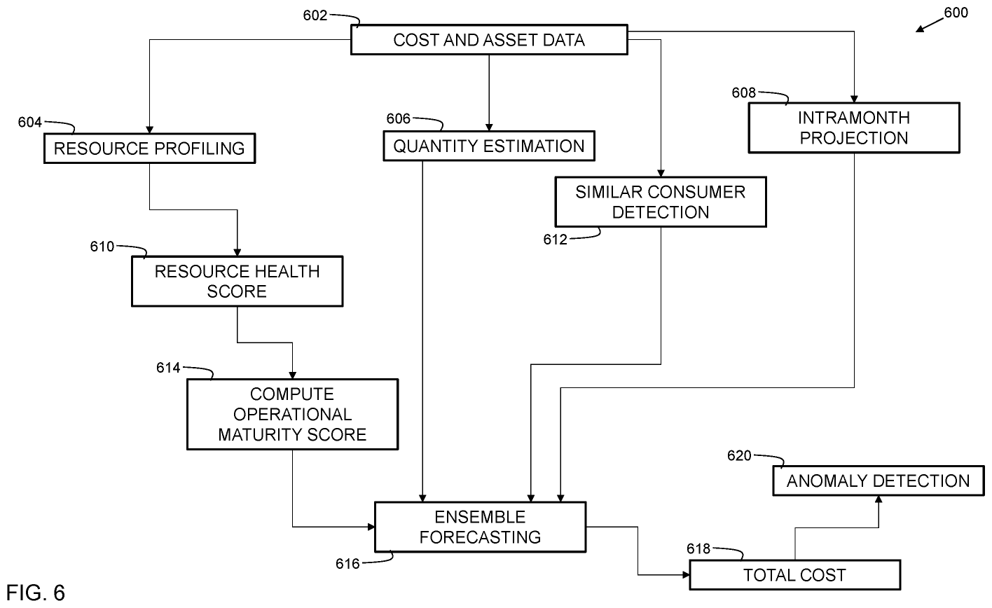

FIG. 6 is a flow diagram 600 showing additional details of embodiments of the present invention. The flow includes obtaining cost and asset data 602. This can include obtaining data from configuration files to indicate the number of resources currently being used. The resources can include virtual machines (VMs), containers, storage nodes, bandwidth, availability levels, and/or other cloud computing resources. The flow can include performing resource profiling 604. The resource profile can include classifying a resource as a production resource or a non-production resource. A non-production resource may be a temporary resource, and/or a resource that is currently in pre-deployment testing. In contrast, a production resource may include a fully tested and deployed resource. The deployment status (production or non-production) can be used by disclosed embodiments as part of the cloud resource cost prediction. The resource duration category (temporary or permanent) can also be used by disclosed embodiments as part of the cloud resource cost prediction. In embodiments, this information may be retrieved from resource description files. The resource description files can include files in a variety of formats, including, but not limited to, text, CSV (comma-separated values), JSON (JavaScript Object Notation), XML (Extensible Markup Language), and/or YAML. In embodiments, computing the resource profile comprises: determining a duration category for the one or more cloud resources; and determining a deployment status for the one or more cloud resources.

The flow can include performing a quantity estimation 606. This can include, for each asset, performing a forecast to project a predetermined timeframe into the future for quantity utilization per asset category. In some embodiments, the predetermined timeframe is three months. Other timeframes can be used with disclosed embodiments. The flow can include performing similar consumer detection 612. This can include identifying other consumers (customers) that have similar cloud resource usage and spending as the current client undergoing forecasting. In embodiments, other consumers (e.g., other companies that use similar cloud computing resources) may opt in to allow their data to be used as part of a knowledgebase. In some embodiments, the data may be anonymized such that sensitive information such as the name and/or location of the company may be stripped from the data in the knowledgebase. Certain metadata may be partially obfuscated and/or generalized prior to entry into the knowledgebase. The flow can include performing an intramonth projection 608. The intramonth projection can be used to accommodate newly added assets. This information can be used to update dashboards and generate alerts to keep stakeholders informed of the current state of utilization and spending for cloud computing resources.

The flow can include computing a resource health score 610. In embodiments, the resource health score is a numerical representation of confidence that a given cloud computing resource is not experiencing a problem state that could cause failure, excessive slowness, and/or abnormal execution of assigned operations. In embodiments, for each relevant performance indicator, such as a metric, log, alert sequence, incident set, or the like, a scoring function is applied to produce a numerical assessment of if that aspect of resource performance is likely to contribute to a problem state with the given cloud resource. The scoring functions can vary based on the type of indicator, and can include anomaly detection or recent values within a time series. In embodiments, the resource health scores can be a function of performance indicators such as metrics and alerts, as well as health influencer scores.

The flow can include computing an operational maturity score 614. In embodiments, computing the operational maturity score comprises inputting resource utilization and cloud service type into the neural network. The cloud service type can include, but is not limited to, IaaS (Infrastructure as a Service), SaaS (Software as a Service), and/or PaaS (Platform as a Service). The flow can include ensemble forecasting 616. In embodiments, the ensemble forecasting can include combining multiple algorithms into a single prediction model. The multiple algorithms can include, but are not limited to, random forest, gradient, deep learning, regression, LSTM, and/or gradient boosted. In embodiments, the output of one algorithm is used as input for another algorithm. The ensemble forecasting can serve to process output from other components to provide a total cost at 618. The flow can then continue to anomaly detection 620, which can provide notification to users in situations such as a projected cost exceeding a preestablished budget. In some embodiments, the predefined threshold can be a currency amount (e.g., US Dollars, Euros, etc.). In some embodiments, the predefined threshold can be indicated as a percentage increase. As an example, a cost that increases more than ten percent over the previous time period can be used as a criterion for generating an alert. With a data-driven anomaly detection process, the machine learning system identifies patterns that are inconsistent with historical data. In this way, customers can be alerted to anomalies even if they did not specify particular criteria for triggering alerts. The alerts can be generated for historical usage and/or forecasted data.

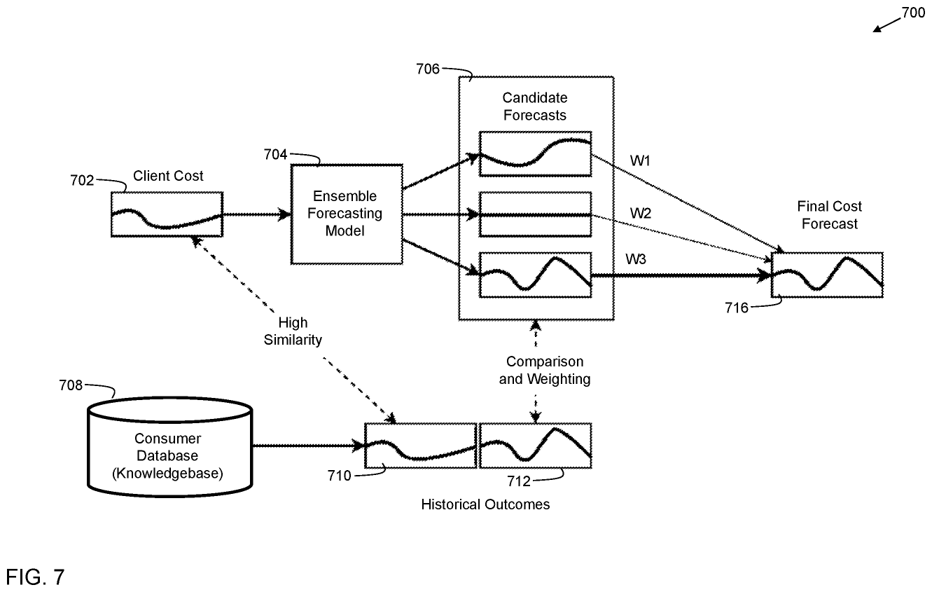

FIG. 7 is a block diagram 700 for cost forecasting in accordance with embodiments of the present invention. The historical costs 702 for a given cloud computing client are input to ensemble forecasting model 704. In embodiments, the ensemble forecasting can include combining multiple algorithms into a single prediction model. The multiple algorithms can include, but are not limited to, random forest, gradient, deep learning, regression, LSTM, and/or gradient boosted. In embodiments, the output of one algorithm is used as input for another algorithm. The ensemble forecasting model 704 can generate multiple candidate forecasts 706. In embodiments, each candidate forecast has a weighting function applied to it (indicated in FIGS. 7 as W1, W2, and W3), to create a final cost forecast 716. In some embodiments, the weighting functions can be predetermined constants. In other embodiments, the weighting functions can change dynamically based on previous forecasting performance.

Embodiments can include utilizing data from consumer database 708. In embodiments, consumer database 708 can include a knowledgebase. The data within database 708 can be used as inputs to a neural network (machine learning system) to perform supervised learning on the neural network to train it to make cost forecasting predictions. The data can include training set input data 710 and training set output data 712. The input data 710 and output data 712 can be used to train machine learning systems used in disclosed embodiments in order to refine the results of the ensemble forecasting model 704.

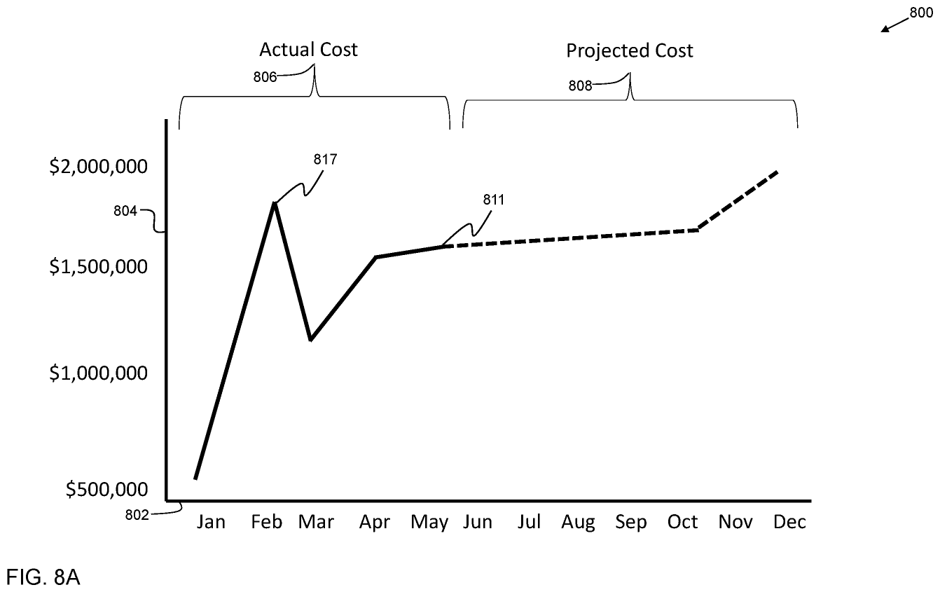

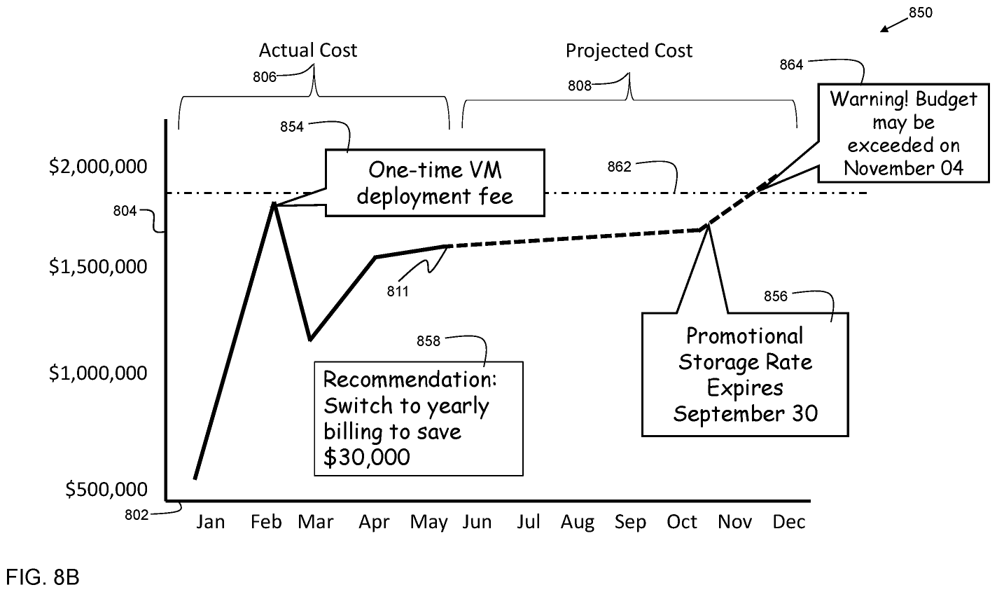

FIG. 8A shows an example 800 of forecast data. The example is a graph having a horizontal axis 802 that represents time, and a vertical axis 804 that represents cost. The cost can be in USD, Euros, or other suitable currency. A curve 811 shows the cost of a cloud computing resource over time. The cloud computing resource can include the cost of operating a collection of virtual machines, containers, storage elements, and/or other cloud computing resources. The curve 811 can be a composite curve that shows a portion of actual cost 806, as well as a projected cost 808, indicated as a dashed line within curve 811. Curve 811 includes resource spike 817. The resource spike 817 is a relative maximum indicating an increased cost. These resource spikes can be a cause of confusion and concern for stakeholders. Disclosed embodiments serve to clarify the cause of such resource spikes based on machine learning techniques, and/or natural language processing.

FIG. 8B shows an example 850 that includes rendering of additional information in accordance with embodiments of the present invention. The information can include a budget 862 as specified by a user. The budget 862 can be used as a criterion for generating alerts based on anomaly detection. In the example 850, an alert 864 is generated and rendered based on the projected cost exceeding the budget 862. In embodiments, the alert may include a forecasted date on which the budget may be exceeded. In addition to alerts pertaining to forecast data, disclosed embodiments may provide additional information on historical data. As an example, a message 854 explains the cause of a spike in price. The spike can be detected by identifying local maxima in curve 811 (see 817 of FIG. 8A). The message 854 indicates a spike cause as a one-time virtual machine deployment fee. In embodiments, this information may be obtained by natural language processing of configuration files, service contracts, and/or other information regarding cloud computing resources. Embodiments can include performing a spike detection process on historical data for the one or more cloud resources to identify a resource spike; obtaining metadata associated with the resource spike; and rendering the metadata proximal to a rendering of the resource spike. The rendering can be performed on an electronic display of an electronic computing device. The example 850 further includes message 856 to explain a forecast trend. The message 856 indicates that a promotional storage rate expires on a given date, which can aid in explaining the reason for the forecasted increase in cost for the cloud computing resource. Embodiments can further include recommendations. Example 850 includes recommendation 858. Recommendation 858 indicates a suggestion to save costs by changing the billing terms. In embodiments, recommendations such as shown at 858 can be based on information obtained from natural language processing of service contracts, invoices, rate tables, and/or other information pertaining to pricing of a cloud computing resource.

As can now be appreciated, disclosed embodiments provide a cost forecasting model specifically tailored to cloud computing resources. Embodiments take into account various factors that are specific to the varying costs of cloud computing resources, such as the cost per asset and permanence of those resources. Disclosed embodiments can provide explanations and cost predictions for inclusion of new cloud computing resources. Furthermore, anomaly-based alerts can be generated based on customer-driven and/or data-defined criteria, thereby helping users estimate cloud computing costs more quickly and accurately. Features of disclosed embodiments enable users to better forecast their budgets, and help identify future needs based on their usage pattern, thus improving the technical field of cloud computing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for cloud computing infrastructure cost forecasting, comprising:
computing a resource profile for at least one cloud resource;
performing a scheduled pattern detection process for each of the at least one cloud resources;
performing a consumer detection process for each of the at least one cloud resources to generate at least one similar consumer pattern;
computing an operational maturity score for the at least one cloud resources;
inputting data to a neural network, wherein the input data includes the resource profile, the operational maturity score, the at least one similar consumer pattern; an output of the scheduled pattern detection process; and an output of the similar consumer detection process; and
obtaining a cost forecast from the neural network, based on the input data.

2. The method of claim 1, further comprising:
performing a spike detection process on historical data for the at least one cloud resources to identify a resource spike;
obtaining metadata associated with the resource spike; and
rendering the metadata proximal to a rendering of the resource spike.

3. The method of claim 1, wherein computing the resource profile comprises:
determining a duration category for the at least one cloud resources; and
determining a deployment status for the at least one cloud resources.

4. The method of claim 1, wherein performing a scheduled pattern detection process comprises:
analyzing a historical pattern for each of the at least one cloud resources; and
identifying a periodicity for the historical pattern.

5. The method of claim 4, wherein the historical pattern includes one of, weekly, quarterly, weekend, and daily.

6. The method of claim 1, further comprising performing an anomaly detection process.

7. The method of claim 6, wherein the anomaly detection process comprises a customer-defined anomaly detection process.

8. The method of claim 7, wherein the anomaly detection process comprises a data-driven anomaly detection process.

9. The method of claim 6, further comprising generating an alert in response to detecting an anomaly from the anomaly detection process.

10. The method of claim 1, wherein computing the operational maturity score comprises inputting resource utilization and cloud service type into the neural network.

11. The method of claim 1, wherein the neural network includes one of Long Short Term Memory Network (LSTM), Radial Basis Function Network (RBFN), Multilayer Perceptron (MLP), and Gradient Boosted Network.

12. An electronic computation device comprising:
a processor;
a memory coupled to the processor, the memory containing instructions, that when executed by the processor, cause the electronic computation device to:
compute a resource profile for at least one cloud resource;
perform a scheduled pattern detection process for each of the at least one cloud resources;
perform a consumer detection process for each of the at least one cloud resources to generate at least one similar consumer pattern;
compute an operational maturity score for the at least one cloud resources;
input data to a neural network, wherein the input data includes the resource profile, the operational maturity score, the at least one similar consumer pattern; an output of the scheduled pattern detection process; and an output of the similar consumer detection process; and
obtain a cost forecast from the neural network, based on the input data.

13. The electronic computation device of claim 12, wherein the memory further comprises instructions, that when executed by the processor, cause the electronic computation device to:
perform a spike detection process on historical data for the at least one cloud resources to identify a resource spike;
obtain metadata associated with the resource spike; and
render the metadata proximal to a rendering of the resource spike.

14. The electronic computation device of claim 12, wherein the memory further comprises instructions, that when executed by the processor, cause the electronic computation device to:
analyze a historical pattern for each of the at least one cloud resources; and
identify a periodicity for the historical pattern.

15. The electronic computation device of claim 14, wherein the memory further comprises instructions, that when executed by the processor, cause the electronic computation device to identify the historical pattern as one of weekly, quarterly, weekend, or daily.

16. The electronic computation device of claim 12, wherein the memory further comprises instructions, that when executed by the processor, cause the electronic computation device to perform an anomaly detection process.

17. A computer program product for an electronic computation device comprising a computer readable storage medium having program instructions embodied therewith, the program instructions executable by a processor to cause the electronic computation device to:
compute a resource profile for at least one cloud resource;
perform a scheduled pattern detection process for each of the at least one cloud resources;
perform a consumer detection process for each of the at least one cloud resources to generate at least one similar consumer pattern;
compute an operational maturity score for the at least one cloud resources;
input data to a neural network, wherein the input data includes the resource profile, the operational maturity score, the at least one similar consumer pattern; an output of the scheduled pattern detection process; and an output of the similar consumer detection process; and
obtain a cost forecast from the neural network, based on the input data.

18. The computer program product of claim 17, wherein the computer readable storage medium includes program instructions executable by the processor to cause the electronic computation device to:
perform a spike detection process on historical data for the at least one cloud resources to identify a resource spike;
obtain metadata associated with the resource spike; and
render the metadata proximal to a rendering of the resource spike.

19. The computer program product of claim 17, wherein the computer readable storage medium includes program instructions executable by the processor to cause the electronic computation device to:
analyze a historical pattern for each of the at least one cloud resources; and
identify a periodicity for the historical pattern.

20. The computer program product of claim 19, wherein the computer readable storage medium includes program instructions executable by the processor to cause the electronic computation device to identify the historical pattern as one of weekly, quarterly, weekend, or daily.
